(19) United States
(12) Patent Application Publication
(10) Pub. No.: US 2004/0097318 A1
(43) Pub. Date: May 20, 2004

(54) Drvie comprising a motor and at least one gear assembly connected downstream of said motor

(76) Inventors: Ingo Greuel, Munchen (DE); Dietmar Orth, Karlsfeld (DE); Holger Schiffer, Meerbusch (DE); Bernd Ulbricht, Markt Indersdorf (DE)

Correspondence Address: Liniak Berenato, Longacre & White, Suite 240, 6550 Rock Spring Drive, Bethesda, MD, 20817, US

(21) Appl. No.: 10/473,982

(22) PCT Filed: Apr. 9, 2002
(86) PCT No.: PCT/EP02/03896

(30) Foreign Application Priority Data
Apr. 10, 2001 (DE) 101 17 934.0

(51) Int. Cl. F16H 48/06

(52) U.S. Cl. 475/149

(57) ABSTRACT

A drive includes a motor (5) and at least one gear assembly (7) that is connected downstream of the motor (5) for vehicles comprising a door (1) that can be closed automatically. The output shaft (28) of the gear assembly (7) is disengaged from the drive shaft (27) in such a way that during the manual actuation of the units connected to the output shaft (28), (e.g. tailgate of the vehicle,) their displacement is not restricted by the units connected to the drive shaft (27) of the coupling (e.g. electromotor (5) or intermediate gear (6)), thus preventing wear of the units. The gear assembly (7) can be disengaged and comprises a gear-assembly housing (21) with a cylindrical cavity (22), in which a planetary gear (23;38), provided with a housing (26;39) and concentric drive and output shafts (27,28), is rotatably mounted.

The invention relates to a drive comprising a motor and at least one gear assembly connected downstream of said motor, in particular for motor vehicles having an automatically actuable vehicle door, tailgate, hood or the like (referred to collectively below as vehicle door).

In the case of motor vehicles having an automatically closable tailgate, the tailgate is, for example, closed or opened by the driver of the vehicle by a corresponding actuation of a switch provided in the instrument panel. For this purpose, the switching signal produced by the switch acts on an electronic control device which, for its part, produces electric control signals to activate an electric motor which then, for its part, uses a gear assembly connected downstream and further transmission elements to pivot the tailgate.

Among the disadvantages of these known vehicles is that, when shutting the tailgate manually, a high resistance has to be overcome due to the gear assembly or the motor being operatively connected to the tailgate, and increased wear of these components occurs.

The invention is based on the object of specifying a drive, in particular for motor vehicles having an automatically actuable vehicle door, in which the output shaft of the gear assembly can be disengaged from the drive shaft in a simple manner, so that, when the constructional units (for example, tailgate of the vehicle), which are arranged on the output shaft of the coupling, are actuated manually, their movement is not impeded by the constructional units (for example, electric motor or intermediate gear assembly) arranged on the drive shaft of the coupling, and wear of these constructional units is avoided.

This object is achieved according to the invention by the features of claim 1. Further particularly advantageous refinements of the invention are disclosed in the subclaims.

The invention is based essentially on the concept of using, as the gear assembly, a disengageable gear assembly which comprises a gear-assembly housing with a cylindrical cavity, in which a planetary gear which is provided with a housing and has concentric gear drive and output shafts is rotatably mounted, and the housing of the planetary gear being able to be fixed via a braking device, which can be actuated by an actuator, in a manner such that it is rotationally fixed with respect to the gear-assembly housing. (The planetary gear therefore refers here to a gear assembly, in which the housing of a corresponding step-up gear together with the wheels mounted therein is mounted rotatably in the gear-assembly housing.)

As planetary gear, use can be made, for example, of a sun-and-planet gear which is provided with a sun wheel, planet wheels and a ring gear. The drive shaft and the output shaft are two of the three coaxial axes of rotation of the sun-and-planet gear (sun-wheel axis, ring-gear axis, planet-wheel-carrier axis), while the third axis in each case of the sun-and-planet gear is connected to the housing of the planetary gear.

In order, when the output shaft of the disengageable gear assembly is loaded (for example by manual closing of the tailgate of a motor vehicle), to avoid effects on the motor or on an intermediate gear assembly optionally situated between the motor and coupling, the disengageable gear assembly is disengaged in its starting position. As soon as, in contrast, for example the tailgate of the corresponding vehicle is to be closed by means of the motor, the braking device is activated and connects the ring gear of the sun-and-planet gear in a rotationally fixed manner to the gear-assembly housing, with the result that the disengageable gear assembly acts as a stationary gear assembly. The motor is then energized and uses the gear assemblies and other possible transmission elements to pivot the hinge strap with the tailgate.

In order to construct the drive according to the invention such that it is particularly compact, it has proven advantageous to use the sun-wheel axis as the drive shaft of the gear assembly and to use the planet-wheel-carrier axis (web-type shaft) of the sun-and-planet gear as the output shaft. In this case, the ring-gear axis can be releasably fixed in relation to the gear-assembly housing in a simple manner by the braking device acting on the outer surface of the ring gear. For this purpose, the braking device is provided with a braking part which, when the braking device is activated, is moved toward the surface of the ring gear and connects the latter in a rotationally fixed manner to the gear-assembly housing.

The braking part of the braking device of the disengageable gear assembly is preferably designed in such a manner that, when the braking device is activated, said braking part forms a frictional connection to the surface of the housing of the planetary gear. However, the braking device may also be designed in a manner such that it can be connected positively or non-positively to the housing.

It has furthermore proven advantageous if the drive is constructed as a pre-manufacturable module, the dimensions and/or the configurations of the gear-assembly housing being selected in such a manner that all of the drive components required for pivoting the vehicle door, such an electric motor, control device, sensors, mechanical transmission elements, hinge straps, gas-filled springs and dampers etc., are surrounded by the gear-assembly housing and/or are fastened thereto.

Further details and advantages of the invention emerge from the following exemplary embodiments which are explained with reference to figures, in which:

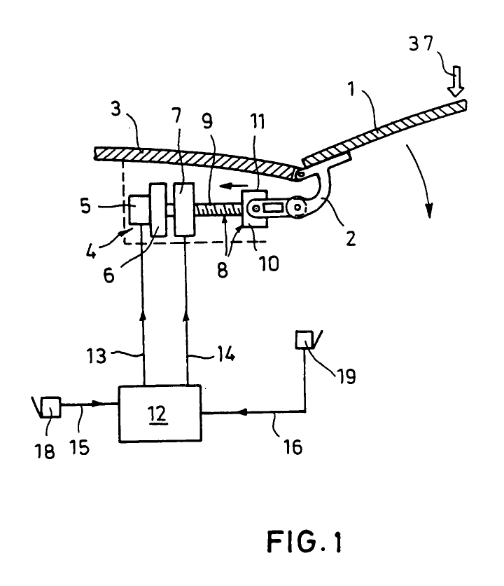

FIG. 1 shows a schematically illustrated side view of the tailgate of a motor vehicle with a drive according to the invention which comprises a disengageable gear assembly containing a planetary gear and is used for opening and closing the tailgate, and an electronic switching device for actuating the disengageable gear assembly;

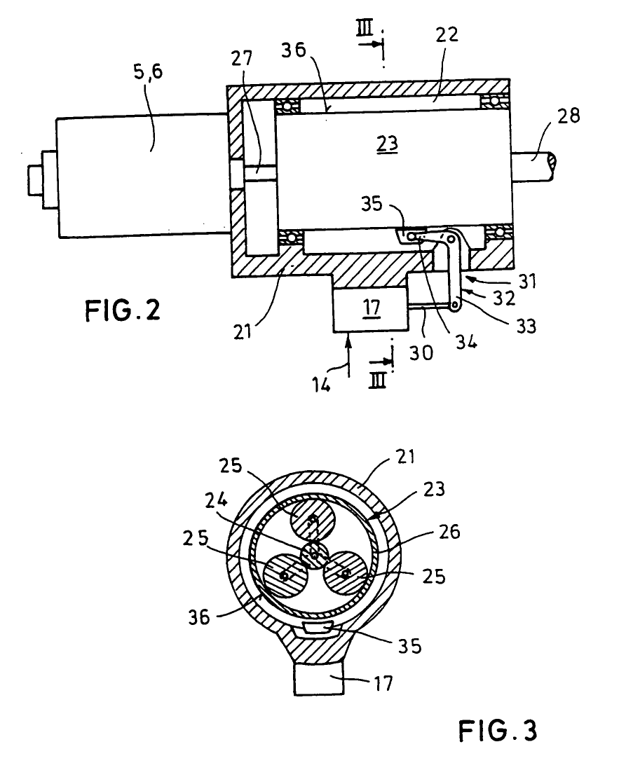

FIG. 2 shows the side view of a disengageable gear assembly;

FIG. 3 shows a cross section of the gear assembly illustrated in FIG. 2 along the section line referred to therein by III-III; and

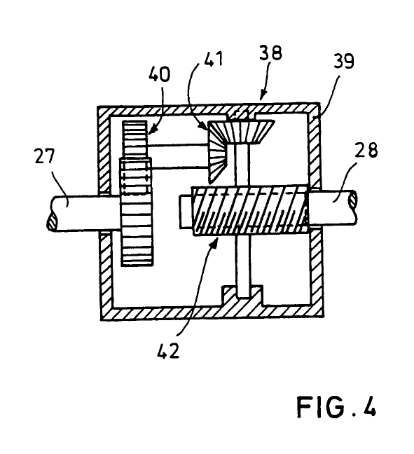

FIG. 4 shows a further exemplary embodiment of a planetary gear.

In FIG. 1, 1 refers to the tailgate of a motor vehicle which is arranged on the roof support 3 of the corresponding vehicle in a manner such that it can be pivoted via hinge straps 2. The tailgate 1 is in its open position.

The hinge strap 2 is connected to a drive 4 which is fastened to the roof support 3. In this case, the drive 4 comprises an electric motor 5 and an intermediate gear assembly 6 which is connected downstream of said motor and acts with a spindle drive 8 via a disengageable gear assembly 7. The spindle drive 8 comprises a rotatable spindle 9 and a spindle nut 10 which is displaced axially upon rotation of the spindle 9. The spindle nut 10 is connected to the hinge strap 2 of the tailgate 1 via a transmission element 11.

As can be gathered from FIG. 1, a control device 12 is furthermore provided which is connected via corresponding lines 13-16 to the electric motor 5, to an actuator 17 (FIG. 2) for actuating the disengageable gear assembly 7, to a switch 18 for initiating the automatic closing of the tailgate 1 and to a switch 19 for switching off the motor 5 as soon as the tailgate 1 is closed.

A disengageable gear assembly 7 is illustrated in FIGS. 2 and 3. It essentially comprises a gear-assembly housing 21 to which the electric motor 5 with the intermediate gear assembly 6 is fastened laterally. The gear-assembly housing 21 has a cavity 22 in the shape of a circular cylinder, in which a planetary gear 23 is rotatably mounted. The planetary gear 23 is sun-and-planet gear which comprises a sun wheel 24, three planet wheels 25 arranged uniformly over the circumference and a ring gear 26 which is provided with an internal toothing. Said ring gear at the same time forms the housing of the planetary gear 23.

The drive shaft 27 of the disengageable gear assembly 7 is the sun-wheel axis and the output shaft 28 is the planet-wheel-carrier axis (the planet-wheel-carrier is illustrated in FIG. 3 by dashed lines).

The actuator 17, which is arranged on the outside of the gear-assembly housing 21, is connected via a mechanical connection 30 to a braking device 31. The latter essentially comprises a reversing lever 32, the first lever arm 33 of which protrudes on the outside out of the gear-assembly housing 21 and can be actuated by the mechanical connection 30, and the second lever arm 34 of which is connected to a shoe-shaped braking part 35 which faces the outer surface 36 of the ring gear 26.

The operation of the drive according to the invention will be discussed below. It should be assumed for this that the tailgate 1 is in its open position (FIG. 1).

If the tailgate is now to be closed manually, then it is pressed downward in the direction of the arrow designated by 37 until it is closed. Since the disengageable gear assembly 7 is disengaged in its starting position, the intermediate gear assembly 6 and the electric motor 5 are not loaded by this operation.

If the tailgate 1 is to be automatically closed by the electric motor 5, then after the switch 18 is closed, the actuator 17 is energized by the control device 12 via the electric line 14 and activates the braking device 31. As a result, the braking part 35 is pushed against the outer surface 36 of the housing 26, thus forming a frictional connection between the housing 26 and gear-assembly housing 21. The sun-and-planet gear 23 now acts as a stationary gear. The electric motor 5 is then energized with the aid of the control device 12. The electric motor 5 is then connected via the intermediate gear assembly 6, the disengageable gear assembly 7 and the spindle drive 8 to the transmission element 11, which pivots the hinge strap 2 and therefore also the tailgate 1.

As soon as the tailgate 1 has reached its closed position, the switch 19, which is connected to the control device 12 via the line 16, causes the electric motor 5 to be switched off.

Of course, the invention is not restricted to the exemplary embodiment described above. For example, other axes of the sun-and-planet gear may also be used as drive and output shafts of the disengageable gear assembly. In these cases, the braking device then has to act in each case on the axis which still remains free or on parts which are connected in a rotationally fixed manner to it.

In addition, the braking part does not absolutely have to be a shoe-shaped part. On the contrary, brake bands are also conceivable which are guided around the ring gear and are tightened when the brake device is activated, thus producing an extensive frictional zone. It is also conceivable to design the braking part to be tooth-shaped, said part, when the braking device is activated, engaging positively in a toothed rim arranged around the ring gear.

Finally, the planetary gear does not absolutely have to be a sun-and-planet gear, but rather it may also be any other desired step-up gear with concentric drive and output shafts as long as the housing carries the wheel mountings and is itself mounted rotatably in the main gear-assembly housing.

A corresponding planetary gear which is not a sun-and-planet gear is reproduced in FIG. 4. In this case, the planetary gear is referred to 38 and the housing by 39. In this case, the drive shaft 27 acts on the output shaft 28 via a spur gear 40, a bevel gear 41 and a worm gear 42.

### List of Reference Number

1 tailgate, vehicle door

2 hinge strap

3 roof support

4 drive

5 electric motor, motor

6 intermediate gear assembly

7 disengageable gear assembly, gear assembly

8 spindle drive

9 spindle

10 spindle nut

11 transmission element

12 control device

13-16 lines

17 actuator

18 switch

19 switch

21 gear-assembly housing

22 cavity

23 planetary gear, sun-and-planet gear

24 sun wheel

25 planet wheels

26 housing, ring gear

27 drive shaft

28 output shaft

30 mechanical connection

31 braking device

32 reversing lever

33 first lever arm

34 second lever arm

35 braking part

36 outer surface

37 arrow

38 planetary gear

39 housing

40 spur gear

41 bevel gear

42 worm gear

1. A drive comprising a motor (5) and at least one gear assembly (7) connected downstream of the motor (5), in particular for motor vehicles having an automatically closable vehicle door, tailgate, hood or the like, having the following features:
a) the gear assembly (7) is a disengageable gear assembly which comprises a gear-assembly housing (21) with a cylindrical cavity (22), in which a planetary gear (23; 38) which is provided with a housing (26; 39) and has concentric gear drive and output shafts (27, 28) is rotatably mounted, and
b) the housing (26; 39) of the planetary gear (23; 38) can be fixed via a braking device (31), which can be actuated by an actuator (17), in a manner such that it is rotationally fixed with respect to the gear-assembly housing (21).

2. The drive as claimed in claim 1, characterized by the following features:
a) the planetary gear (23) is a sun-and-planet gear which is provided with a sun wheel (24), planet wheels (25) and a ring gear (26);
b) the drive shaft (27) and the output shaft (28) of the disengageable gear assembly (7) are two of the three coaxial axes of rotation (sun-wheel axis, ring-gear axis and planet-wheel-carrier axis) of the sun-and-planet gear (23), and
c) the third axis in each case of the sun-and-planet gear (23) is connected to the housing (26) of the planetary gear (23).

3. The drive as claimed in claim 2, characterized in that the drive shaft (27) of the disengageable gear assembly (7) is the sun-wheel axis and the output shaft (28) is the planet-wheel-carrier axis of the sun-and-planet gear (23), and in that the ring gear (26) forms the housing of the planetary gear (23).

4. The drive as claimed in one of claims 1 to 3, characterized in that, in order to fix the housing (26; 39) of the planetary gear (23; 38) in relation to the gear-assembly housing (21), the braking device (31) comprises a braking part (35) which faces the outer surface (36) of the housing (26; 39) and which, when the braking device (31) is activated, is moved toward the outer surface (36) of the housing (26; 39) and connects the latter in a rotationally fixed manner to the gear-assembly housing (21).

5. The drive as claimed in claim 4, characterized in that the braking part (35) of the braking device (31) is designed in such a manner that, when the braking device (31) is activated, said braking part forms a frictional or positive connection to the outer surface (36) of the housing (26; 39) of the planetary gear (23; 38).

6. The drive as claimed in either of claims 4 or 5, characterized in that the actuator (17) of the disengageable gear assembly (7) is arranged on the outer circumference of the gear-assembly housing (21), and in that the actuator (17) is connected via a mechanical connection (30) to the braking device (31), which comprises a pivotable reversing lever (32), the first lever arm (33) of the reversing lever (32) being at least partially arranged outside the gear-assembly housing (21) and the second lever arm (34) being connected to the braking part (35).

7. The drive as claimed in one of claims 3 to 6, characterized in that the braking part (35) of the disengageable gear assembly (7) is of shoe-shaped design.

8. The drive as claimed in one of claims 1 to 7, characterized in that the drive (4) comprises an electric motor (5), the output shaft of which is connected in a rotationally fixed manner directly or via an intermediate gear assembly (6) to the drive shaft (27) of the disengageable gear assembly (7), and in that the housing of the electric motor (5) and/or of the intermediate gear assembly (6) is/are connected non-positively to the gear-assembly housing (21).

9. The drive as claimed in one of claims 1 to 8, characterized in that the drive (4) is a pre-manufacturable module, the dimensions and/or the configurations of the gear-assembly housing (21) being selected in such a manner that all of the drive components required for pivoting a vehicle door, such as an electric motor (5), control device (12), mechanical transmission elements (11), hinge straps (2), gas-filled springs and dampers etc., are surrounded by the gear-assembly housing (21) and/or are fastened thereto.
